(19) United States
(12) Patent Application Publication
(10) Pub. No.: US 2021/0392087 A1
(43) Pub. Date: Dec. 16, 2021

(54) COMPUTER SYSTEM AND OPERATION MANAGEMENT METHOD FOR COMPUTER SYSTEM

(71) Applicant: Hitachi, Ltd., Tokyo (JP)

(72) Inventors: Tsukasa SHIBAYAMA, Tokyo (JP); Akira DEGUCHI, Tokyo (JP)

(73) Assignee: Hitachi, Ltd., Tokyo (JP)

(21) Appl. No.: 17/197,240

(22) Filed: Mar. 10, 2021

(30) Foreign Application Priority Data
Jun. 16, 2020 (JP) 2020-103539

(51) Int. Cl. H04L 12/927; H04L 12/911

(52) U.S. Cl. CPC H04L 47/805; H04L 47/822

(57) ABSTRACT

The computer system includes a management unit that holds a service template in which a service provided by the host is described, and a necessary resource table in which a resource amount necessary for the node is described so as to execute the service with a predetermined parameter. The management unit receives input of the service template and the parameter, calculates a necessary resource amount based on a combination of the input service template and parameter with reference to the necessary resource table, selects a node that satisfies a condition for the calculated necessary resource amount, executes a service for the service template, and updates the necessary resource table based on a change in a load of the resource before and during the service is executed.

### BACKGROUND OF THE INVENTION

The present invention relates to a computer system and an operation management method for a computer system.

In recent years, in order to reduce operation cost of a computer system, an automation of a management operation has progressed, and there is a technique for automatically executing a series of management operations by using templates and configuration definition files. For example, WO 2016/084255 A discloses a management system that creates a service template and manages a target device by generating and executing an operation service based on the created service template and a value obtained by inputting the service template to an input property.

### SUMMARY OF THE INVENTION

However, the above-mentioned related art has a problem that a load may be imbalanced and a resource may not be used efficiently after the service template is executed. Even when a series of the management operation is automated by executing the service template, there is a possibility that a processing in which the load is imbalanced may be executed unless an administrator who has knowledge about the execution base of the operation service grasps the load state by using a management tool. Especially, in an environment where many workloads operate as in a private cloud or in a large-scale environment such as a scale-out environment, the load is imbalanced and the resource cannot be used efficiently. Therefore, the operation cost is increased.

The present invention has been made in consideration of the above points, and one object of the present invention is to realize the automation of an operation management of a target device in consideration of a load.

In order to solve the above problems, according to an aspect of the invention, there is provided a computer system that includes a plurality of nodes having a processor, and a storage device, the nodes processing data input and output to the storage device by a host by using the processor, the computer system including a management unit that holds a service template in which a service provided by the host is described, and a necessary resource table in which a resource amount of a resource necessary for the node is described so as to execute the service with a predetermined parameter. The management unit receives input of the service template and the parameter, calculates a necessary resource amount based on a combination of the input service template and parameter with reference to the necessary resource table, selects a node that satisfies a condition for the calculated necessary resource amount, executes a service for the service template, and updates the necessary resource table based on a change in a load of the resource before and during the service is executed.

According to the aspect of the present invention, for example, it is possible to realize the automation of the operation management of the target device in consideration of the load.

### BRIEF DESCRIPTION OF THE DRAWINGS

FIG. 1 is an explanatory diagram of an outline of Embodiment 1;

FIG. 2 is a diagram illustrating an overall configuration of a computer system according to Embodiment 1;

FIG. 3 is a configuration diagram of a node according to Embodiment 1;

FIG. 4 is a configuration diagram of a host according to Embodiment 1;

FIG. 5 is a diagram illustrating a logical configuration of a computer system according to Embodiment 1;

FIG. 6 is a diagram illustrating a program and information in a memory in a node according to Embodiment 1;

FIG. 7A is a table illustrating node hardware information included in a device hardware configuration table according to Embodiment 1;

FIG. 7B is a table illustrating node port hardware information included in a device hardware configuration table according to Embodiment 1;

FIG. 7C is a table illustrating drive hardware information included in a device hardware configuration table according to Embodiment 1;

FIG. 7D is a table illustrating host port hardware information included in a device hardware configuration table according to Embodiment 1;

FIG. 8A is a table illustrating pool configuration information included in a logical configuration table according to Embodiment 1;

FIG. 8B is a table illustrating volume configuration information included in a logical configuration table according to Embodiment 1;

FIG. 9A is a table illustrating volume IO amount operation information included in an operation information management table according to Embodiment 1;

FIG. 9B is a table illustrating node performance operation information included in an operation information management table according to Embodiment 1;

FIG. 10 is a table illustrating a service template according to Embodiment 1;

FIG. 11 is a table illustrating a necessary resource table according to Embodiment 1;

FIG. 12 is a flowchart illustrating a service execution processing according to Embodiment 1;

FIG. 13 is a flowchart illustrating a necessary resource table update processing according to Embodiment 1;

FIG. 14 is a diagram illustrating a functional configuration of a computer system according to Embodiment 2;

FIG. 15 is a diagram illustrating a program and data in a memory in a node according to Embodiment 2;

FIG. 16A is a table illustrating data store configuration information further included in a logical configuration table according to Embodiment 2;

FIG. 16B is a table illustrating VM configuration information further included in a logical configuration table according to Embodiment 2;

FIG. 17 is a table illustrating VM performance operation information further included in an operation information management table according to Embodiment 2;

FIG. 18 is a diagram illustrating an overall configuration of a computer system according to Embodiment 3;

FIG. 19 is a diagram illustrating a program and data in a memory in a node according to Embodiment 4;

FIG. 20 is a table illustrating an SLA table according to Embodiment 4;

FIG. 21 is a table illustrating a host allocation resource table according to Embodiment 4;

FIG. 22A is a flowchart illustrating a service execution processing according to Embodiment 4; and

FIG. 22B is a flowchart illustrating a service execution processing according to Embodiment 4.

### DESCRIPTION OF THE PREFERRED EMBODIMENTS

Hereinafter, preferred embodiments of the present invention will be described. In the following, the same or similar elements and processing will be denoted by the same reference numerals to describe the differences, and overlapped description will be omitted. In the embodiment which will be described, the difference from the existing embodiment will be described, and the overlapped description will be omitted.

In addition, a configuration and processing which are described in the following description and illustrated in each drawing exemplify an outline of the embodiment to the extent necessary for understanding and implementing the present invention, and are not intended to limit the embodiments according to the present invention. A part or all of each embodiment and modification example can be combined within a range not departing from the gist of the present invention.

In the following, similar elements to which signs are added to be distinguished by subscripts or branch numbers added to numbers are collectively referred to by only reference numerals regardless of the subscripts or the branch numbers. For example, elements with signs such as “100a”, and “100b”, or “200-1”, and “200-2” are collectively referred to by adding reference numerals such as “100”, and “200”. Similar elements such as “XX interface 14a” and “YY interface 14b” in which subscripts and branch numbers are added to the numbers are collectively referred to by using a common part of the element name and only a reference numeral, for example, “interface 14”.

Although various information will be described below in a table format, the information is not limited to the table format, and may be in a document format or other formats. A configuration of the table is an example, and the table can be integrated and distributed appropriately. In the following, IDs and names listed as items (columns) in each table may be any numbers or character strings as long as records can be distinguished.

In the following, processing may be described with a “program” as the subject. Since a program is executed by a processor (for example, a central processing unit (CPU)) to perform a predetermined processing by appropriately using a storage resource (for example, a memory) and/or a communication interface device (for example, a communication port), the subject of the processing may be a processor. The processing described with the program as the subject may be processing performed by a processor or a device having the processor.

The processor that executes the program can also be called “XXX unit” as a device that implements a desired processing function. The processor may also include a hardware circuit that perform a part or all of the processing. The program may be installed on each controller from a program source. The program source may be, for example, a program distribution computer or a computer-readable storage medium.

### Embodiment 1

### Outline of Embodiment 1

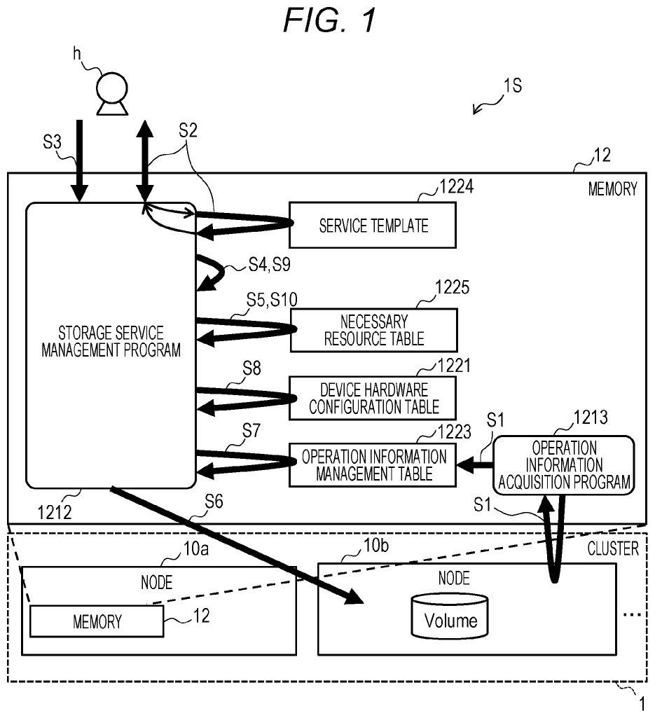

First, an outline of Embodiment 1 of the present invention will be described with reference to FIG. 1. FIG. 1 is an explanatory diagram of an outline of Embodiment 1. A computer system 1S illustrated in FIG. 1 includes a cluster 1 of a storage, the cluster including nodes 10a and 10b. A memory 12 of the cluster 1 stores a storage service management program 1212, an operation information acquisition program 1213, a device hardware configuration table 1221, an operation information management table 1223, a service template 1224, and a necessary resource table 1225. Each of the nodes 10a and 10b provides a volume to the host that issues IO to the cluster 1.

Step S1 indicates an operation information acquisition processing. The operation information acquisition program 1213 periodically executes processing of Step S1. In Step S1, the operation information acquisition program 1213 collects operation information from all devices which are management targets (nodes 10a and 10b in FIG. 1). Operation information, for example, is time-series information such as the number of IOs issued by the host in the case of a volume, and time-series information such as a CPU utilization, a memory usage, and a used communication band in the case of a node. Subsequently, the operation information acquisition program 1213 stores the collected operation information in the operation information management table 1223 as a history.

Steps S2 to S6 indicates service execution processing. In Step S2, the storage service management program 1212 selects a template of the service to be executed (a template in which the processing and its execution order are described) from the service template 1224 according to the management operation by an operation administrator h.

Next, in Step S3, the storage service management program 1212 receives an input of a parameter value for the service template selected in Step S3, the parameter value input by the operation administrator h via a management terminal. The parameter includes a requirement of an application (hereinafter, referred to as application requirement) operated by executing a service.

Next, in Step S4, the storage service management program 1212 determines processing based on the service template selected in Step S3 and the parameter input in Step S3. Next, in Step S5, the storage service management program 1212 confirms resource information necessary for executing the service (necessary resource amount) when the service template with the same parameter input in Step S3 exists in the necessary resource table 1225.

Next, in step S6, the storage service management program 1212 searches for a node 10 that satisfies a condition for the necessary resource amount confirmed in Step S6, and executes the processing determined in Step S4 in the node 10 that satisfies the condition (executes the service). In the example of FIG. 1, the processing is to deploy the volume, the condition is to satisfy a computer resource, and the volume is deployed to the node 10b with the best condition (for example, the lightest load).

In addition to deploying the storage volume, the processing includes various operations related to a storage such as a pool creation, a snapshot creation, and a copying. In addition to satisfying the computer resource, the condition includes satisfying availability that the processing is performed in a plurality of nodes to improve fault tolerance.

Steps S7 to S10 indicate necessary resource table update processing after the service is executed. In Step S7, the storage service management program 1212 refers to the operation information management table 1223, and calculates a difference of the operation information before and after the service is executed.

Next, in Step S8, the storage service management program 1212 acquires the device hardware configuration table 1221. Next, in step S9, the storage service management program 1212 calculates the necessary resource amount after service is executed from the difference of the operation information calculated in Step S7 and the device hardware configuration table 1221. Next, in Step S10, the storage service management program 1212 updates the necessary resource table 1225 based on the necessary resource amount calculated in Step S9.

By executing the service based on the necessary resource table 1225 updated in this way, automation of the operation management is realized such that the processing can be executed in an appropriate place in consideration of a change of a load which is suitable for an individual customer environment and a dynamic change of the load in the customer environment.

Overall Configuration of Computer System of Embodiment 1

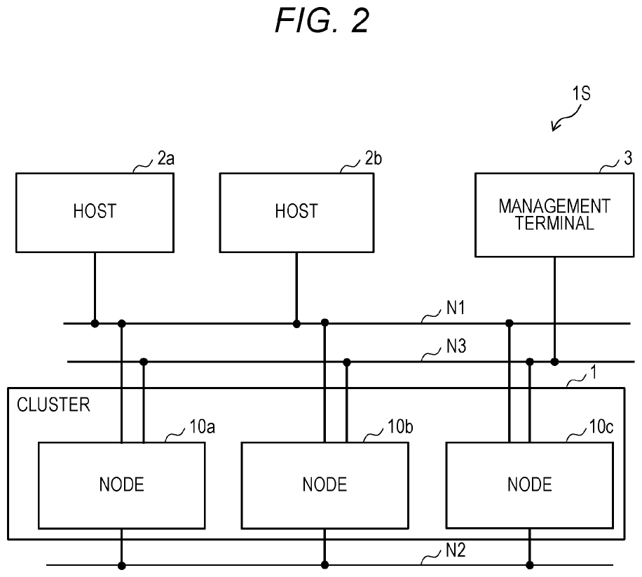

FIG. 2 is a diagram illustrating an overall configuration of a computer system 1S according to Embodiment 1. The computer system 1S includes a cluster 1, one or more hosts 2, and a management terminal 3. In the computer system 1S, the host 2 and the node 10 are connected with each other via a front-end network N1. The nodes 10 are connected to each other via a back-end network N2. The management terminal 3 and the node 10 are connected with each other via a management network N3.

The front-end network N1, the back-end network N2, and the management network N3 may be the same networks or different networks. These networks may be redundant. These networks may be Ethernet (registered trademark, the same applies hereafter), InfiniBand (registered trademark, the same applies hereafter), or wireless.

The cluster 1 includes one or more nodes 10. The node 10 is a storage node configured of a general-purpose server.

The host 2 issues data IO to the cluster 1. The host 2 may be a bare-metal server or a server on which a hypervisor runs. When the hypervisor runs on the server, a virtual machine (VM) runs on the hypervisor.

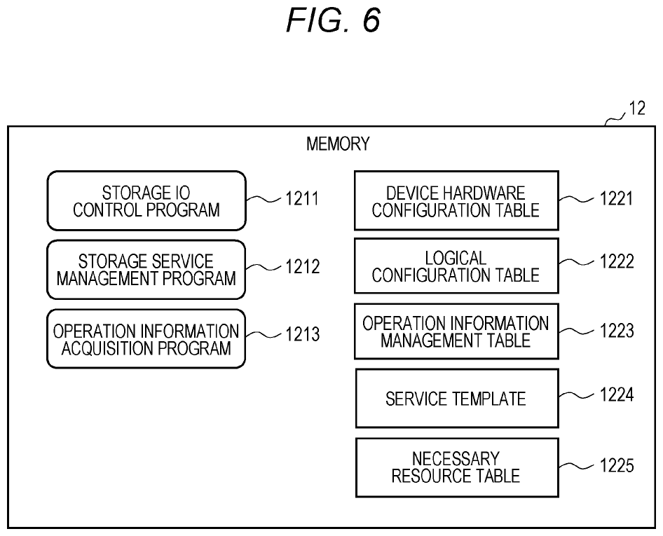

The management terminal 3 is a terminal for operating the storage service management program 1212 in the cluster 1. For example, the management terminal 3 sends an operation request input via a GUI such as a browser to the storage service management program 1212 which will be described later with reference to FIG. 6. The management terminal 3 may store the storage service management program 1212, the operation information acquisition program 1213, and various tables, which are stored in the memory 12 in the cluster 1.

FIG. 2 illustrates an example in which the cluster 1 is configured to include the nodes 10a, 10b, and 10c. FIG. 2 illustrates an example in which the host 2 includes two hosts 2a and 2b. However, the number of nodes 10, and the number of hosts 2, which configure the cluster 1, are not limited to this.

### Configuration of Node in Embodiment 1

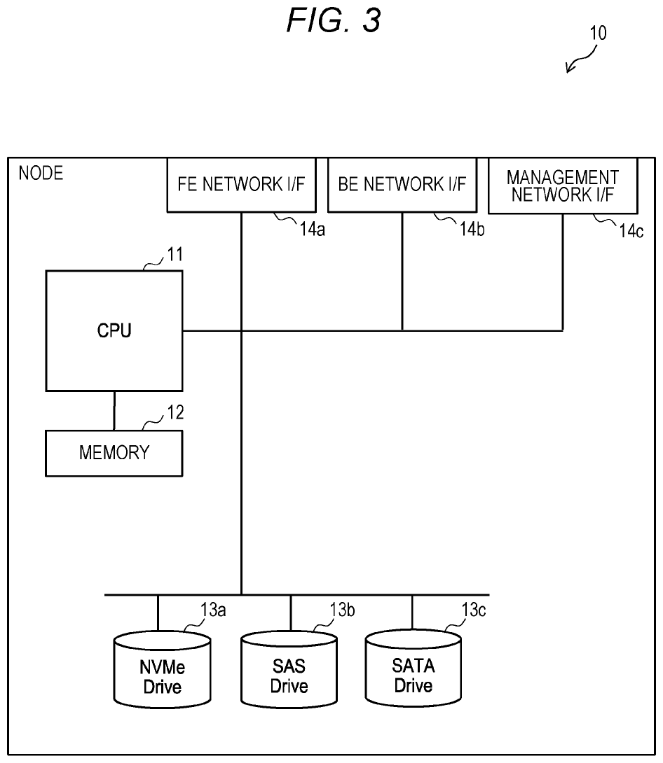

FIG. 3 is a configuration diagram of the node 10 according to Embodiment 1. The node 10 includes a central processing unit (CPU) 11 which is an example of a processor, a memory 12 which is an example of a storage unit, a drive 13, and a network I/F 14. The number of CPUs 11 and memories 12 is not limited to the illustration. The drive 13 may be a hard disk drive (HDD), a solid state drive (SSD), or any other non-volatile memory (a storage class memory (SCM)). In FIG. 3, as the drive 13, three of an NVMe (registered trademark, the same applies hereinafter) drive 13a, an SAS drive 13b, and a SATA drive 13c are illustrated, but an interface type of the drive and the number of the drives are not limited to the illustration.

The network I/F 14 includes a front-end (FE) network I/F 14a, a back-end (BE) network I/F 14b, and a management network I/F 14c. The FE network I/F 14a is an interface that is connected to the front-end network N1 for communicating with the host 2. The BE network I/F 14b is an interface that is connected to the back-end network N2 for communication between the nodes 10. The management network I/F 14c is an interface that is connected to the management network N3 for communicating with the management terminal 3.

The network I/F 14 may be an interface of any of Fibre Channel, Ethernet, and InfiniBand. The network I/F 14 may be provided in each network or may be provided as a common interface.

### Configuration of Host in Embodiment 1

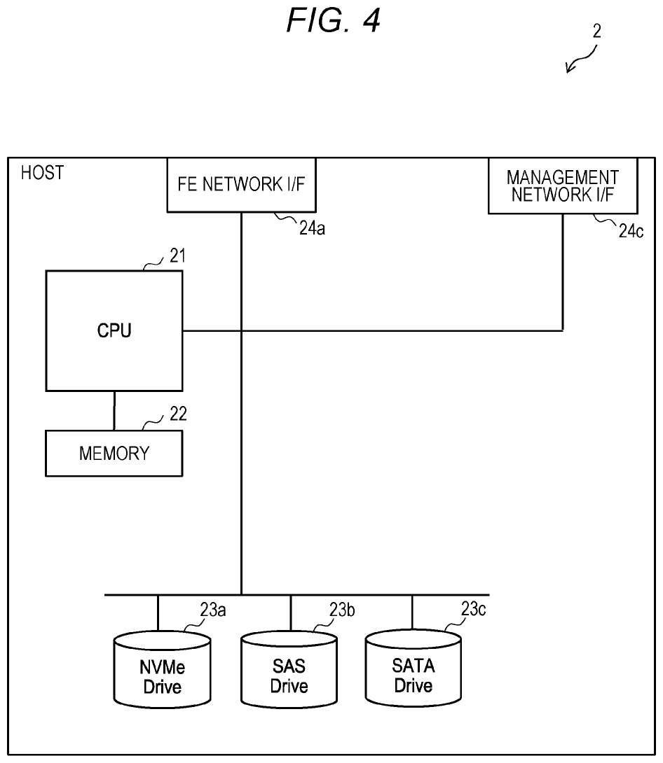

FIG. 4 is a configuration diagram of the host 2 according to Embodiment 1. The host 2 includes a CPU 21, a memory 22, a drive 23, and a network I/F 24. The number of the CPUs 21 and the memories 22 is not limited to the illustration. The drive 23 may be a HDD, an SSD, or any other non-volatile memory. In FIG. 4, as the drive 23, three of an NVMe drive 23a, an SAS drive 23b, and a SATA drive 23c are illustrated, but an interface type of the drive and the number of the drives are not limited to the illustration.

The network I/F 24 includes a FE network I/F 24a and a management network I/F 24c. The FE network I/F 24a is an interface that is connected to the front-end network N1 for communicating with the host 2. The management network I/F 24c is an interface that is connected to the management network N3 for communicating with the management terminal 3.

### Logical Configuration of Computer System of Embodiment 1

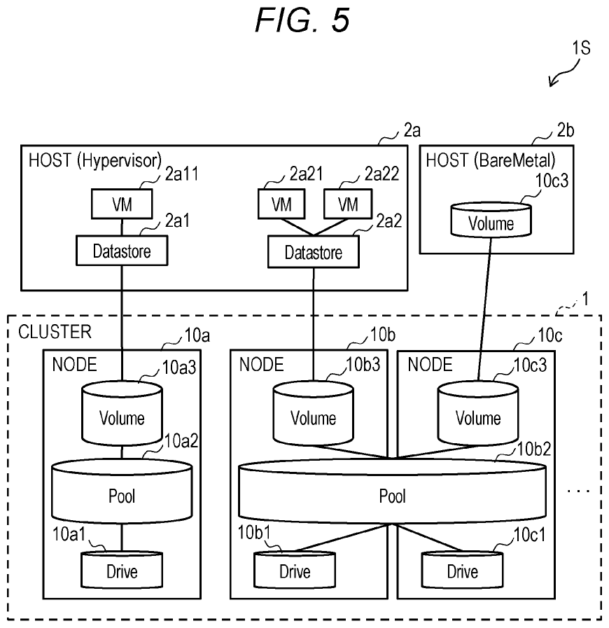

FIG. 5 is a diagram illustrating a logical configuration of the computer system 1S according to Embodiment 1. In the logical configuration example of the computer system 1S illustrated in FIG. 5, only drives 10a1, 10b1, and 10c1 are physically connected to nodes 10 (10a, 10b, and 10c) respectively, and the configurations other than the drive are logical resources. The hierarchy above pools 10a2, and 10b2 indicates the logical configuration as seen from the storage service management program 1212 which will be described later with reference to FIG. 6.

As illustrated in FIG. 5, there is one or more pools in one cluster 1. The pool may be provided across the nodes 10 or provided to be closed in the node 10. The pool may have a hierarchical structure for facilitating management. As the hierarchical structure, there is an example in which one or more pools that are closed in the node 10 are combined to form a pool that straddles the nodes 10.

A physical storage area of the pool is allocated from the drive. Volumes 10a3, 10b3, and 10c3 are curved from the pool. The volume may be closed in the node 10 or straddle the nodes 10. The physical storage areas of one or more drives are directly allocated to the volumes without defining the pool.

The host 2 includes a server on which a hypervisor for managing a virtual machine (VM) runs, and a bare-metal server that directly mounts the volume. In the example of FIG. 5, the host 2a is the server on which the hypervisor runs, and a host 2b is the bare-metal server.

The server on which the hypervisor runs creates a data store that uses the mounted volume as a logical storage area. In the example of FIG. 5, the host 2a creates a data store 2a1 that uses the volume 10a3 of the node 10a as a logical storage area and a data store 2a2 that uses the volume 10b3 of the node 10b as a logical storage area.

In the bare-metal server, an operating system (OS) on the server mounts the volume as a logical storage area. In the example of FIG. 5, in the host 2b, the OS on the server mounts the volume 10c3 of the node 10c as a logical storage area.

The host 2a deploys a VM from the data store. In the example of FIG. 5, a VM 2a11 is deployed from a data store 2a1, and a VMs 2a21, and 2a22 are deployed from the data store 2a2.

The relationship between the numbers of the volume, the data store, and the VM is not particularly limited, and Volume:Datastore:VM=x:y:z is satisfied for arbitrary positive integers x, y, and z. The relationship among the volume, the data store, and the VM is managed by the storage service management program 1212, and the logical configuration table 1222 in the memory 12, which are will be described later.

### Program and Data on Memory in Node of Embodiment 1

FIG. 6 is a diagram illustrating a program and information in the memory 12 in the node 10 according to Embodiment 1. A storage IO control program 1211, the storage service management program 1212, and the operation information acquisition program 1213 are stored in the memory 12. The device hardware configuration table 1221, the logical configuration table 1222, the operation information management table 1223, the service template 1224, and the necessary resource table 1225 are stored in the memory 12.

As illustrated in FIG. 6, various programs and information stored in the memory 12 may be stored in the memory 12 of any one node 10 configuring the cluster 1, and the same content thereof may be disposed or distributively disposed in the memory 12 of a plurality of the nodes 10 configuring the cluster 1, which is not limited.

The storage IO control program 1211 is a program that realizes a storage controller, and controls IO from host 2. That is, the storage IO control program 1211 controls Read/Write IO for the Volume provided to the host 2.

The storage service management program 1212 is a program that provides a management function for overall storage service. That is, the storage service management program 1212 provides a storage management function (volume creation/deletion, volume path setting, copy creation/deletion function, and the like), and a service management function (function that interprets and executes the processing described in the service template 1224, and the like).

The operation information acquisition program 1213 is a program that acquires and stores operation information (IOPS, Latency, bandwidth, CPU utilization rate, memory utilization rate, and the like) of the node 10 and the volume in cooperation with the storage IO control program 1211.

The device hardware configuration table 1221 includes information on a CPU, a memory, an FE/BE port, and a drive as hardware information related to the node 10, and information on a port connected to the cluster 1 as hardware information related to the host 2. The device hardware configuration table 1221 includes node hardware information 1221a, node FE/BE port hardware information 1221b, drive hardware information 1221c, and host port hardware information 1221d.

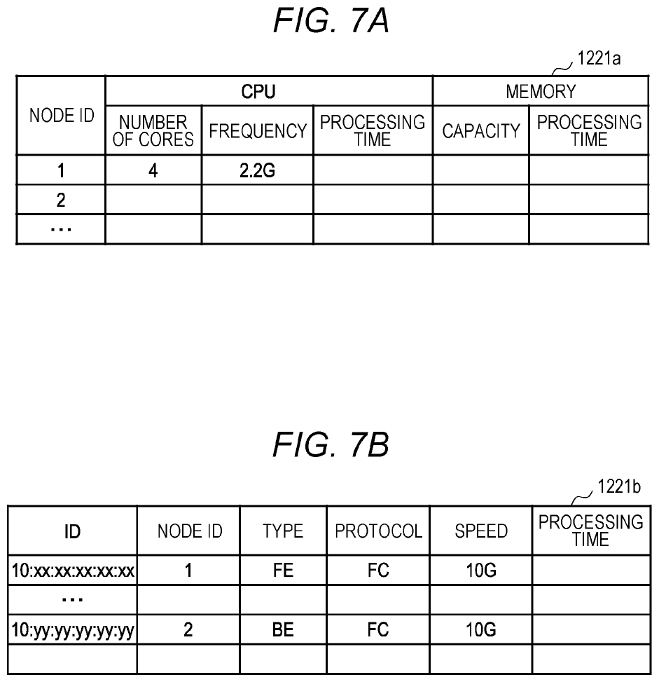

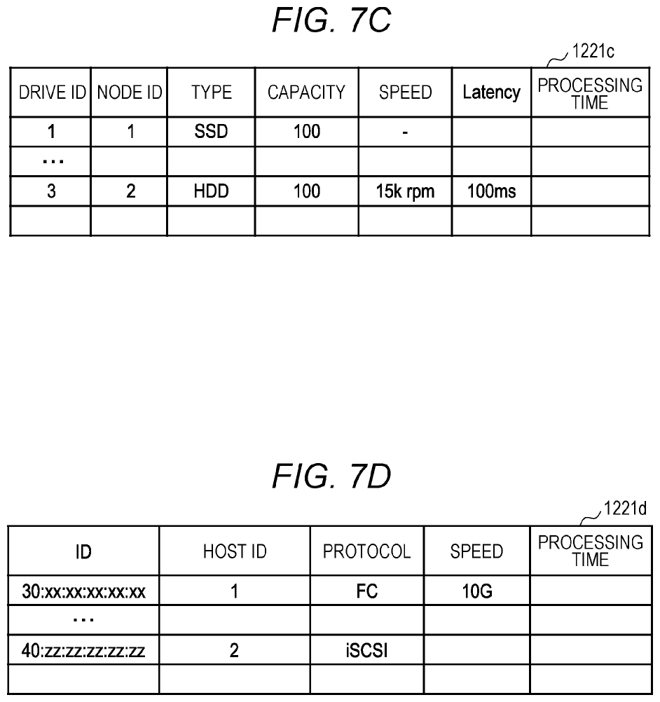

As illustrated in FIG. 7A, the node hardware information 1221a manages the number of cores, a frequency and processing time of the CPU 11, and a capacity and processing time of the memory 12 for each node 10 (node ID) configuring the cluster 1. The node FE/BE port hardware information 1221b manages information on the port included in the node 10, and as illustrated in FIG. 7B, manages a node ID, an FE/BE network type, a protocol, a speed, and processing time for each ID.

As illustrated in FIG. 7C, the drive hardware information 1221c manages a node ID, a drive type, a capacity, a speed, a latency, and processing time for each drive ID.

As illustrated in FIG. 7D, the host port hardware information 1221d manages a host ID, a protocol, a speed, and processing time for each ID of Initiator of the host 2.

Processing time information includes “a time required to process one IO or a calculation model thereof”, and differs for each hardware. For example, the processing time for an HDD is modeled by “seek time+rotation waiting time+data transfer time”. A processing per second (IOPS) of the drive can be theoretically calculated from a reciprocal of the processing time. In the embodiment, the processing time information uses a model measured or calculated for each hardware in advance, and may be set and changed by a user's input.

The logical configuration table 1222 is information indicating a logical resource of the storage for each resource. Here, in general, the pool and the volume are exemplified as a logical resource. For example, the logical configuration table 1222 includes pool configuration information 1222a, and volume configuration information 1222b.

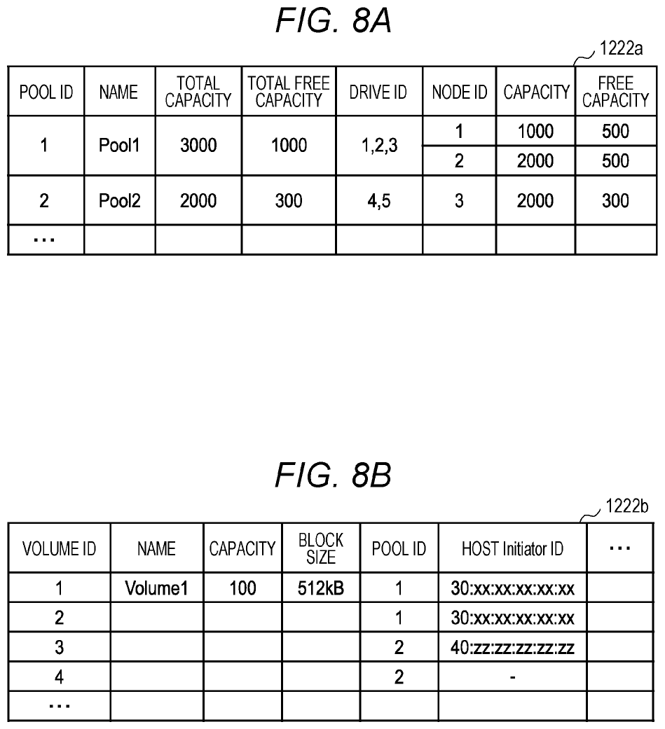

As illustrated in FIG. 8A, the pool configuration information 1222a manages a pool ID, a name, a total capacity and total free capacity of the pool, an ID of the drive that allocates the physical storage area to the pool, a node ID that configures the pool, and a physical capacity and free capacity for each node.

As illustrated in FIG. 8B, the volume configuration information 1222b manages a volume ID, a name, a capacity, a block size, an ID of the pool to which the volume belongs, and Initiator information of the host 2 to which IO can be connected. When the Initiator information is not designated, an access setting from the host 2 is not completed.

The operation information management table 1223 manages the operation information such as the volume and the node 10 in time series. Here, an example in which the operation information management table 1223 includes volume IO operation information 1223a and node performance operation information 1223b will be described.

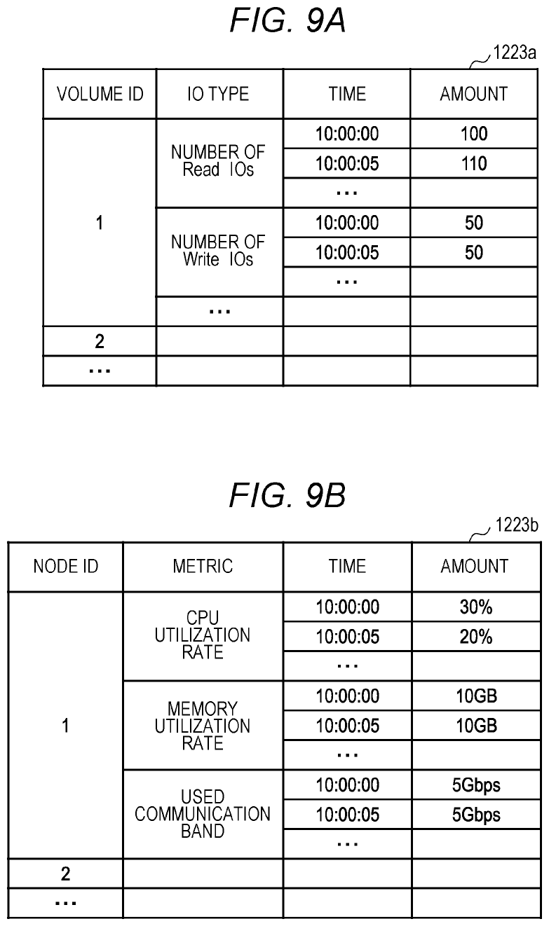

In FIG. 9A, the number of IOs every five seconds (Read IO count, and Write IO count) is described for each volume ID as the volume IO operation information 1223a. However, the volume IO operation information 1223a is not limited to the number of IOs, and may be a latency (response time) or a transfer amount. Read/Write may also be distinguished between Sequential R/W and Random R/W. The time may be any time interval. In FIG. 9A, an instantaneous value is illustrated, but an average value between times may be managed as in IOPS.

In FIG. 9B, as the node performance operation information 1223b, the amount every five seconds for a metric such as a CPU utilization rate, a memory utilization rate, and a communication bandwidth is described for each node ID. However, the metric is not limited to these, and the CPU 11 may hold information on an IO amount that can be further processed by the CPU 11 with an extra capacity (calculated from remaining CPU utilization rate (100%−CPU utilization rate) and number of IOs that can be read and written in a unit of time) or information on a memory utilization rate and the like. As the metric, information such as a data transfer amount of the port and the operation rate of the drive may be held as well.

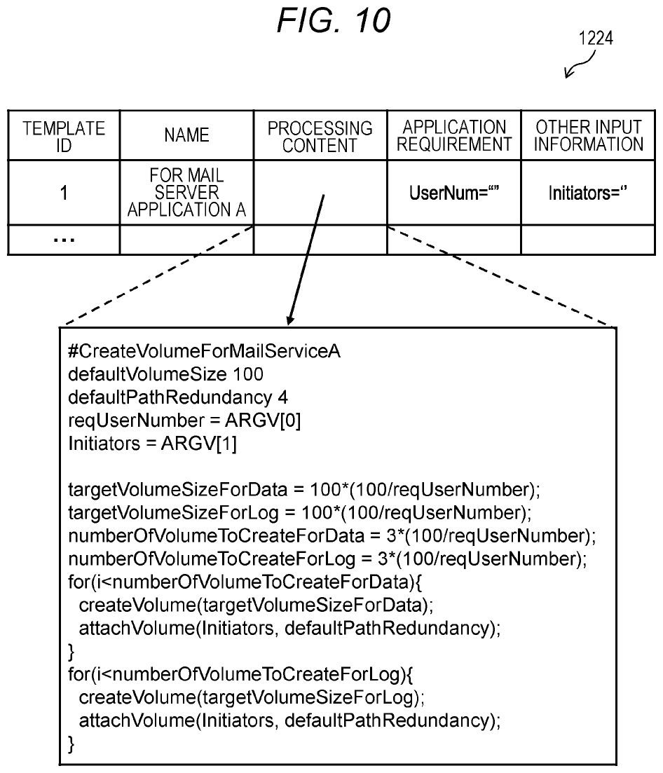

The service template 1224 is a template in which a service, and a series of processing and sequential order for creating a configuration that realizes the service are described. As illustrated in FIG. 10, the service template 1224 includes a template ID, a name of the template, a processing content, an application requirement, and other input information necessary for creating other configurations. The service and the application are examples of use of the computer system 1S including the storage.

The processing content is a pseudo code that describes processing for creating a configuration for realizing the service in an execution order, and FIG. 10 illustrates an example thereof. The application requirement sets an application requirement such as size for realizing the service and availability, which is not directly related to a storage device configuration. However, when the service template 1224 is used to automatically implement a series of processing, a parameter indicating the storage device configuration may be input. One or more application requirements may be input. The application requirement is determined depending on the type of the template (a series of processing described in the processing content).

Other input information indicates essential input information that is not determined only by the application requirement, and although only one of “Initiators” is illustrated in FIG. 10, a plurality of other input information may be input.

The example illustrated in FIG. 10 describes a template of an operation for deploying a necessary configuration “for a mail server application A”. Since a necessary size of a data area, necessary size of a log area, and the number of necessary volumes differ depending on the scale of the number of users using a mail, it is necessary to input the number of mail service users as an application requirement. FIG. 10 illustrates that it is necessary to input Initiator information indicating which host 2 and path are set, which is further necessary for creating the configuration, as other input information.

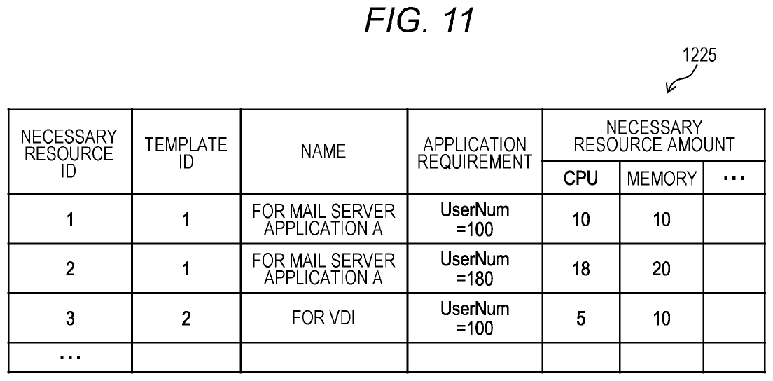

The necessary resource table 1225 is information for holding the necessary resource amount for each combination of the template ID and the parameter (application requirement) of the service template 1224. The necessary resource table 1225 is used to deploy the configuration in a right place when deploying the configuration or changing the deployment. The necessary resource table 1225 includes the resource amount necessary for deploying the service and is managed by the storage service management program 1212. As illustrated in FIG. 11, the necessary resource table 1225 indicates a correspondence relationship among a template ID, a name, an application requirement, and a necessary resource amount for each necessary resource ID.

The application requirement is information that is a requirement for executing the application, and is the same information as the application requirement illustrated in FIG. 10. In the example of FIG. 11, “100”, which means the number of users of a mail server application A, is set in the application requirement in a record in which a necessary resource ID is 1. The application requirement may include a plurality of information in addition to the number of users.

The necessary resource amount indicates the hardware requirement necessary for satisfying the application requirement set in the application. When the necessary resource ID is 1, it is indicated that 10% of the CPU utilization rate is necessary and 10 GB of the memory is necessary. That is, when the mail server application A is deployed with 100 users, it is determined that the mail server application A has to be deployed in the node 10 having a free resource of 10% of the CPU and 10 GB of the memory.

In the example of FIG. 11, when hardware specifications of all the nodes 10 are homogeneous, the necessary resource table 1225 indicates the case where the necessary resource amount is on only one row for each necessary resource ID. However, the necessary resource amount is not limited to this, and for each necessary resource ID, a row for each physical resource may be divided to have a plurality of rows for the necessary resource amount, and the necessary resource amount may be described for hardware of each node. The node 10 can be distributed to deploy a plurality of volumes based on the necessary resource amount having a plurality of rows for the same necessary resource ID in the necessary resource table 1225.

Even in a case of the template that deploys the same application, when the application requirement is different, another necessary resource ID is set since the necessary resource amount is different.

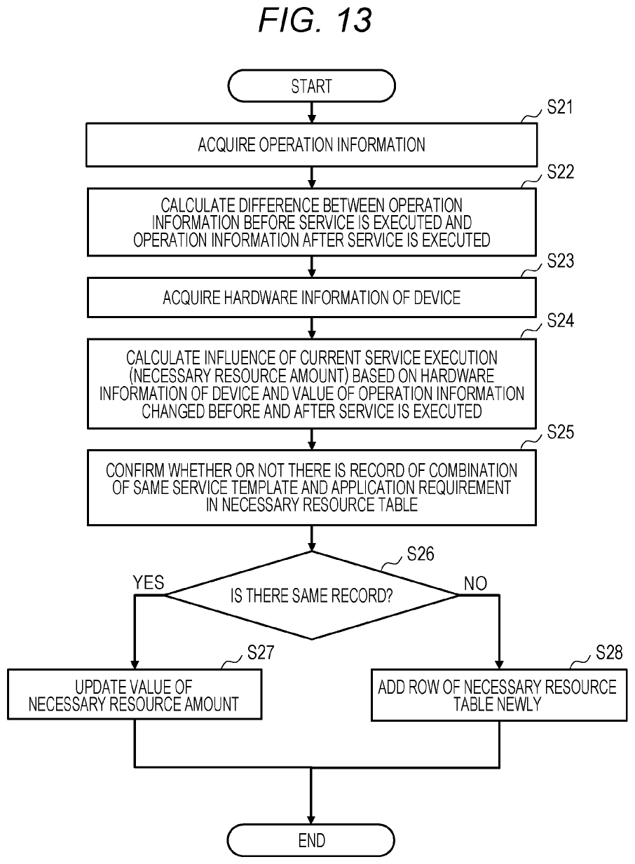

Then, in the necessary resource amount update processing described later with reference to FIG. 13, when the necessary resource is reviewed after the service execution of deploying and changing the configuration, the necessary resource table 1225 is updated to apply the reviewed result. In a case where the necessary resource table 1225 is updated, when an application which is not registered and the application requirement are combined in the necessary resource table 1225, a new record is added.

The necessary resource table 1225 is updated after the service is executed in the necessary resource amount update processing illustrated in FIG. 13, but at the beginning of the operation, there is no record corresponding to the combination of the application and the application requirement. Therefore, a record in which a value of a necessary resource amount assumed in general is set in advance may be prepared in the necessary resource table 1225.

### Processing Flow of Embodiment 1

The processing flow in Embodiment 1 is divided into two processing flows of service execution processing and necessary resource table update processing after the service is executed. The service execution processing and the necessary resource table update processing after the service is executed assume that the operation information acquisition program 1213 periodically collects operation information from all devices to be managed and stores the collected operation information in the operation information management table 1223.

### Service Execution Processing of Embodiment 1

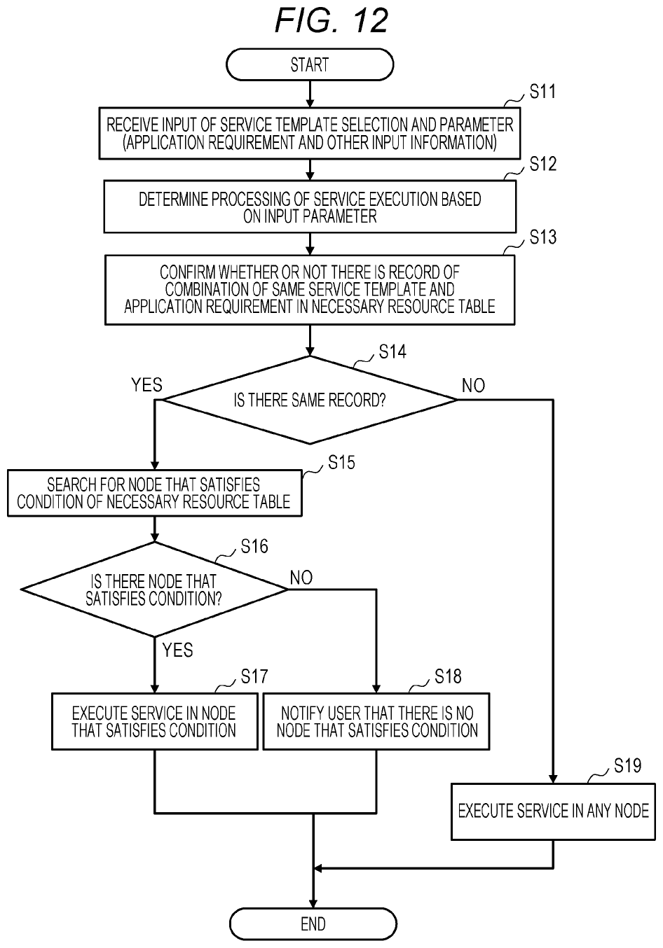

First, the service execution processing will be described. FIG. 12 is a flowchart illustrating the service execution processing according to Embodiment 1.

First, in Step S11, the storage service management program 1212 receives a service template selection(template ID) and a parameter (application requirement and other item information), which are input by the user, via the management terminal 3.

Next, in Step S12, the storage service management program 1212 determines processing based on the template selected in Step S11 and the input parameter value. Next, in Step S13, the storage service management program 1212 confirms whether or not, in the necessary resource table 1225, there is a record of the combination of the same service template and application requirement as the service template and application requirement that are input in Step S11. In the combination of the service template and the application requirement, the service template and the application requirement may not completely match with each other and may be considered to be the same as each other as long as the values are within a range determined in advance.

In the storage service management program 1212, when there is a record of a combination of the same template ID and application requirement as the template ID and application requirement input in Step S11 in the necessary resource table 1225 (YES in Step S14), the processing proceeds to Step S15, and when there is not the record (NO in Step S14), the processing proceeds to Step S19.

In Step S15, the storage service management program 1212 searches for the node 10 that satisfies the condition for the necessary resource amount described in the record of the necessary resource table 1225, the record determined to be the same in step S14. Next, in Step S16, the storage service management program 1212 determines whether or not there is a node 10 that satisfies the condition for the necessary resource amount. In the storage service management program 1212, when there is a node 10 satisfying the condition for the necessary resource (YES in Step S16), the processing proceeds to Step S17, and when there is not the node 10 satisfying the condition for the necessary resource, the processing proceeds to Step S18.

In a case where the application requirement is in a proportional relationship such that the application requirements match each other when the application requirements are N times (or 1/N times), N times (or 1/N times) the necessary resource may be considered to be necessary. For example, when the service template input in Step S11 is for the mail server application A (template ID:1) and the application requirement is UserNum (number of users)=300, in the necessary resource table 1225 illustrated in FIG. 11, CPU: 30%, and Memory: 30 GB obtained by multiplying the necessary resource amount corresponding to Necessary resource ID: 1, Template ID: 1, . . . , Application requirement: UserNum=100 (CPU: 10%, and Memory: 10 GB) by a multiple (N=3) of the application requirement may be set to be a necessary resource amount which is a condition for a node search in Step S15.

The records in the necessary resource table 1225 are grouped by, for example, clustering. Then, in Step S13, the necessary resource amount of a combination of the selected template and the input value of the parameter in Step S11 and a group of a template and parameter having a predetermined similarity degree or more may be set to a necessary resource which is a condition for the node search in Step S15.

In Step S17, the storage service management program 1212 executes a service in any node 10 that satisfies the condition for the necessary resource. On the other hand, in Step S18, the storage service management program 1212 notifies the user that there is no node 10 that satisfies the condition for the necessary resource via the management terminal 3.

In Step S19, the storage service management program 1212 executes the service in any node 10.

As a result of the service execution processing, a series of processing described in the service template 1224 is executed. When there is not information on the necessary resource amount corresponding to the combination of the template ID and the application requirement in the necessary resource table 1225 at the time of an initial execution, the service is executed in any node 10. From the second time on, based on the information on the necessary resource amount in the necessary resource table 1225, it is possible to execute the processing in the appropriate node 10 that satisfies the condition for the necessary resource.

Necessary Resource Table Update Processing of Embodiment 1

Next, the necessary resource table update processing will be described. FIG. 13 is a flowchart illustrating a necessary resource table update processing according to Embodiment 1. The necessary resource table update processing is executed until next service is executed after the previous service is executed and a predetermined time elapses in order to see an operational load trend after the previous service is executed.

First, in Step S21, the storage service management program 1212 acquires operation information with reference to the operation information management table 1223. For example, the operation information acquired in Step S21 is operation information for the past 24 hours based on a time before the service is executed and operation information for the past 24 hours based on a time after the service is executed.

Next, in Step S22, the storage service management program 1212 calculates a difference between the operation information before the service is executed and the operation information after the service is executed.

Next, in Step S23, the storage service management program 1212 acquires each hardware information included in the device hardware configuration table 1221. Next, an influence of this service execution (the resource amount which is necessary after the service execution) is recalculated based on the hardware information acquired in Step S23 and the value of the operation information changed before and after the service is executed.

Here, in the calculation of the influence of the service execution, a general performance estimation calculation method is used. As an example, the maximum increase in an average IOPS over the past 24 hours is considered. The necessary CPU utilization rate can be calculated based on the average IOPS increased before and after the service processing is executed and the processing time of the CPU illustrated in FIG. 7A. The actually increased CPU utilization rate is also acquired, and it is checked whether there is not a discrepancy with the calculated CPU utilization rate. At this time, when there is a discrepancy, the higher CPU utilization rate is adopted. Similarly, the necessary physical resource is calculated based on the processing time of the memory or the drive.

In order to improve the accuracy, the necessary resource amount is stored in time series, and the necessary resource amount is recalculated at a time interval such as a fixed time (for example, one hour unit) in the influence calculation. Accordingly, a node can be arranged in consideration of a workload feature of a specific application at a time unit or in the unit of a day.

The calculation method (estimation based on the processing time of IO) and the calculation target (starting point of calculation of IOPS) for estimating the resource amount are not limited. For example, the maximum increase amount of a simple CPU utilization rate may be used, a method for calculating the calculation target based on the IOPS and a block size illustrated in FIG. 8B by setting the calculation target as a starting point of a data transfer amount.

Next, in Step S25, the storage service management program 1212 confirms whether or not, in the necessary resource table 1225, there is a record of a combination of the same service template (template ID) and application requirement as those in the executed service processing.

In the storage service management program 1212, when there is a record of a combination of the same template ID and application requirement as those in the executed service processing in the necessary resource table 1225 (YES in Step S26), the processing proceeds to Step S27, and when there is not the record (NO in Step S26), the processing proceeds to Step S28.

In step S27, the storage service management program 1212 updates a value of the necessary resource amount of the record in the necessary resource table 1225, the record existing in Step S26. An updating method of the necessary resource table 1225 may be a method for simply overriding the necessary resource table, a method for obtaining an average value of previous and present calculations, or arbitrary means for storing the recalculated necessary resource amount or the necessary resource table 1225 updated in past as a history, and updating the necessary resource table 1225 based on a result of learning the history. By updating the necessary resource table 1225 based on the result of learning the history, it is possible to improve the accuracy of the necessary resource amount by excluding an extremely deviated value.

On the other hand, in Step S28, the storage service management program 1212 newly adds a row in the necessary resource table 1225 having each value of the currently executed service template, the application requirement, and the currently calculated necessary resource amount.

According to this embodiment, in the management operation of the target device, once a parameter such as an application requirement is input, it is possible to create and update a configuration more suitable for each customer environment in consideration of a load balance even when an administrator does not grasp an execution base and a load state of the application and the service.

### Embodiment 2

In Embodiment 1, the configuration in which the cluster 1 of the storage does not include the host 2 in which the data store and the VM are mounted on the hypervisor has been described. On the other hand, in Embodiment 2, a configuration in which a hyper converged infrastructure (HCl) configuration is adopted and a cluster 1B of a storage includes a host in which a data store and a VM are mounted on a hypervisor will be described.

### Function of Computer System of Embodiment 2

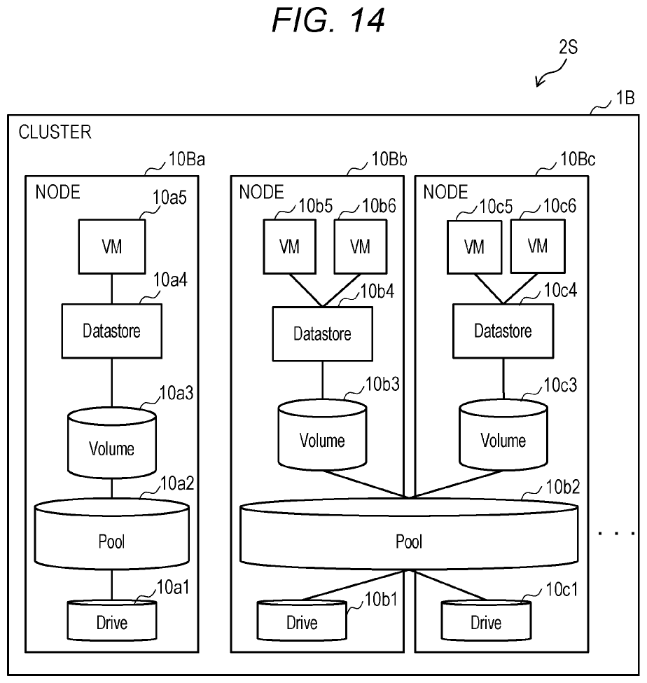

FIG. 14 is a diagram illustrating a functional configuration of a computer system 2S according to Embodiment 2. As illustrated in FIG. 14, the computer system 2S includes a cluster 1B. In FIG. 14, the host and the management terminal are not illustrated.

The cluster 1B includes nodes 10Ba, 10Bb, and 10Bc. The node 10Ba includes a drive 10a1, a pool 10a2, a volume 10a3, a data store 10a4, and a VM 10a5. The node 10Bb includes a drive 10b1, a pool 10b2, a volume 10b3, a data store 10b4, a VM 10b5, and a VM 10b6. The node 10Bc includes a drive 10c1, a pool 10b2, a volume 10c3, a data store 10c4, a VM 10c5, and a VM 10c6. The pool 10b2 is provided across the nodes 10Bb and 10Bc. The VM may be secured in the same node as the volume or in a node different from the volume.

### Program and Data in Memory of Embodiment 2

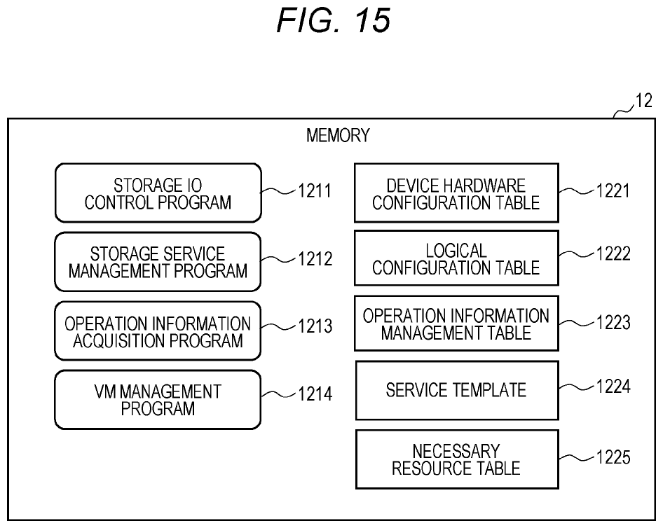

FIG. 15 is a diagram illustrating a program and data in the memory 12 in the node 10B according to Embodiment 2. Compared with Embodiment 1, in Embodiment 2, a VM management program 1214 is further stored in the memory 12.

The VM management program 1214 is a program that executes an operation related to the VM, the operation of creating and deleting the VM, and manages VM operation information. The VM management program 1214 is called when the storage service management program 1212 performs a VM operation in the process of executing the service. The VM management program 1214 returns the operation information in response to the operation information inquiry about the VM, which is received from the operation information acquisition program 1213.

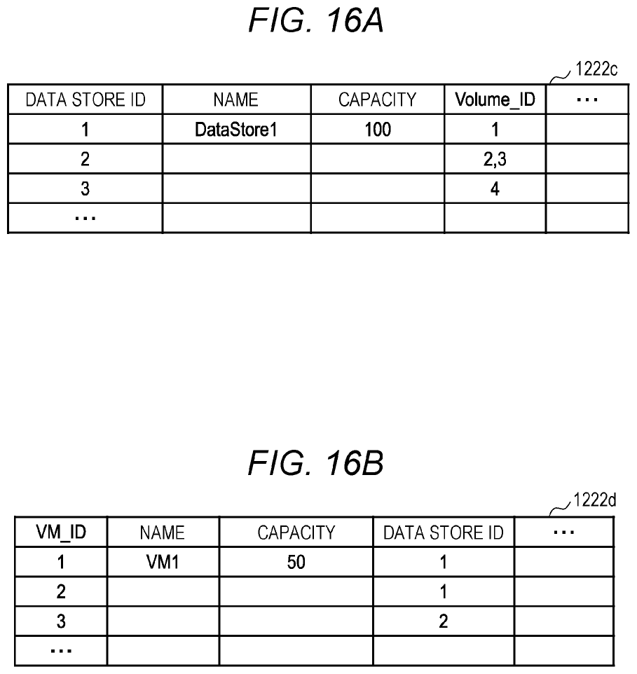

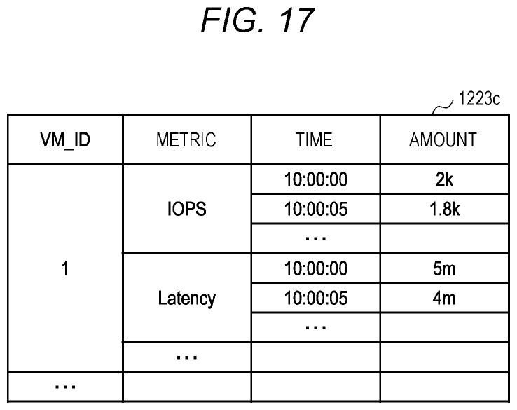

Compared with Embodiment 1, in Embodiment 2, the logical configuration table 1222 further includes data store configuration information 1222c and VM configuration information 1222d. As illustrated in FIG. 16A, the data store configuration information 1222c manages a data store ID, a data store name, a capacity, and a volume ID used by the data store. As illustrated in FIG. 16B, the VM configuration information 1222d manages a VM ID, a name of the VM, a capacity, and an ID of the data store used by the VM.

In Embodiment 2, the operation information management table 1223 further includes VM performance operation information 1223c. As illustrated in FIG. 17, the VM performance operation information 1223c manages an amount every five seconds for a metric such as IOPS and a latency for each VM ID. As in Embodiment 1, a time may be an arbitrary time interval. The metric is not limited to the one illustrated in FIG. 17.

According to the embodiment, even in an HCl configuration in which the cluster of the storage includes the host in which the data store and the VM are mounted on the hypervisor, based on the necessary resource amount in consideration of the VM, as in Embodiment 1, it is possible to create and change a configuration more suitable for each customer environment in consideration of a load balance.

### Embodiment 3

Embodiment 3 is different from Embodiments 1 and 2 in that various programs and data stored in the memory 12 of each node are stored in an external management server 3C. Another difference is that the management server 3C manages a plurality of storage clusters and also manages a storage system that are not in a cluster configuration.

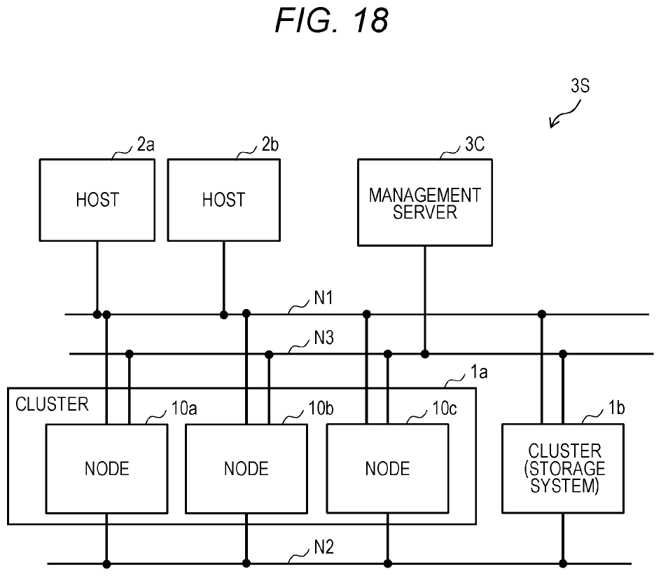

FIG. 18 is a diagram illustrating an overall configuration of a computer system 3S according to Embodiment 3. The management server 3C includes a CPU that executes a program and a memory (not illustrated). The management server 3C stores, the storage service management program 1212, the operation information acquisition program 1213, the device hardware configuration table 1221, the logical configuration table 1222, the operation information management table 1223, the service template 1224, and the necessary resource table 1225 except the storage IO control program 1211 among the program and the information in the memory 12 illustrated in FIG. 6. The management server 3C manages the device hardware configuration table 1221, the logical configuration table 1222, the operation information management table 1223, the service template 1224, and the necessary resource table 1225 in each cluster and storage system. For example, a column in which an ID for identifying a cluster or storage system is stored is added to these tables.

According to the embodiment, even in a configuration in which a plurality of the clusters and storage systems are managed by the management server, it is possible to create and change a configuration of each cluster which is more suitable for each customer environment in consideration of a load balance as in Embodiment 1.

### Embodiment 4

Compared with Embodiment 1, in Embodiment 4, an example in which a requirement for an SLA (hereinafter. referred to as SLA requirement) for each user who executes the application as well as the application requirement are set will be described. A service level agreement (SLA) is generally a level of the service to be observed, which is determined between a service provider and the user.

In the embodiment, as an example of a control executed based on SLA information, the SLA requirement is associated with the host used by the user for each user, and a resource is allocated to each host so as to comply with the SLA requirement. According to this, the level of the service is guaranteed. The allocated resource may be a physical resource (CPU core, memory, drive, port) or a virtual resource. The virtual resource is a resource obtained by mapping and dividing the physical resource to a virtual world, and mapping information of the physical resource and the virtual resource is necessary. In the embodiment, for simplicity, an example of allocating the physical resource is illustrated.

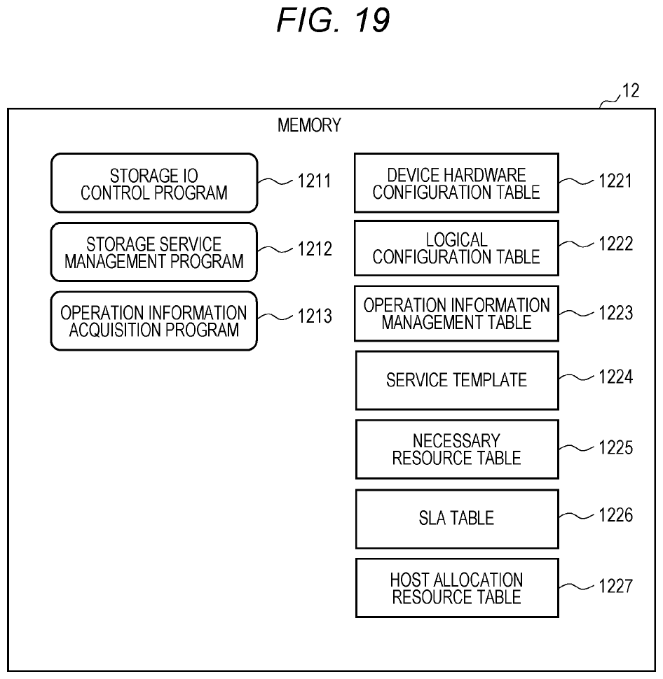

FIG. 19 is a diagram illustrating a program and data in the memory 12 in the node according to Embodiment 4. FIG. 19 is different from FIG. 6 in that an SLA table 1226 and a host allocation resource table 1227 are further stored in the memory 12.

### SLA Table

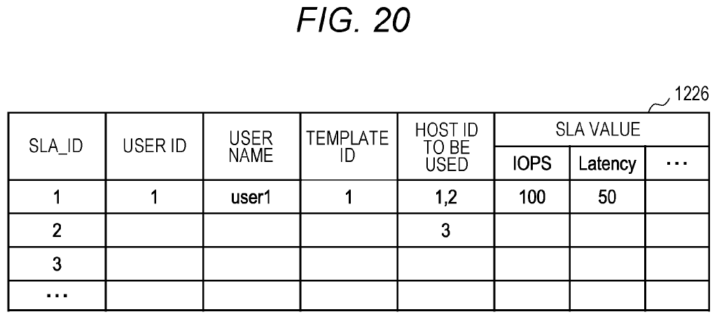

FIG. 20 is a table illustrating the SLA table 1226 according to Embodiment 4. The SLA Table 1226 represents SLA information for each user, which is a unit for guaranteeing the SLA, and is managed by the storage service management program 1212. The SLA Table 1226 includes an SLA_ID, a user ID, a user name, a template ID, a host ID used by the user, and an SLA value, which are SLA identifiers. The host ID is not limited to one host ID, and may be plural. The SLA value indicates a level of a service to be observed in the service used by the user.

For example, in the example illustrated in FIG. 20, in a record of SLA_ID: 1, a template ID: 1 and a user ID: 1 using a host of host IDs: 1 and 2 indicates that IOPS is guaranteed to be 100 or more and a latency is guaranteed to be within 50 msecs.

### Host Allocation Resource Table

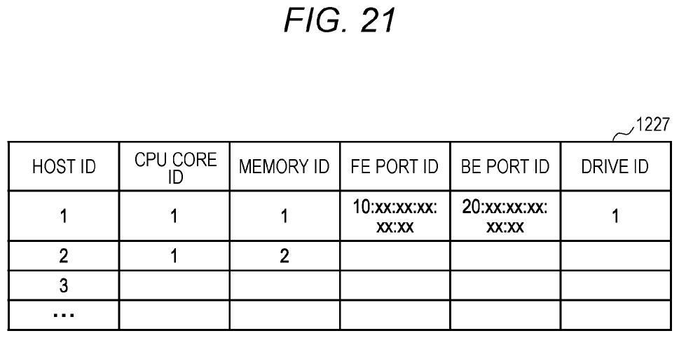

FIG. 21 is a table illustrating a host allocation resource table 1227 according to Embodiment 4. The host allocation resource table 1227 indicates a resource that is managed by the storage service management program 1212, and allocated to each host. In the embodiment, for simplicity, an example of allocating the physical resource is illustrated, but the virtual resource may be managed and allocated.

The host allocation resource table 1227 has values such as a host ID which is a host identifier, a CPU core ID which is a CPU core identifier, a memory ID which is a memory identifier, an FE port ID which is an FE port identifier, a BE port ID which is a BE port identifier, and a drive ID which is a drive identifier.

In the example of FIG. 21, an example in which each column has one value for one record is illustrated, but the present invention is not limited to this, and each column may have a plurality of values. The same resource may be allocated to a host with a different host ID at the same time. In the host allocation resource table 1227, it is not necessary to allocate all the resources corresponding to each column to each host ID, and there may be blanks without setting.

### Service Execution Processing of Embodiment 4

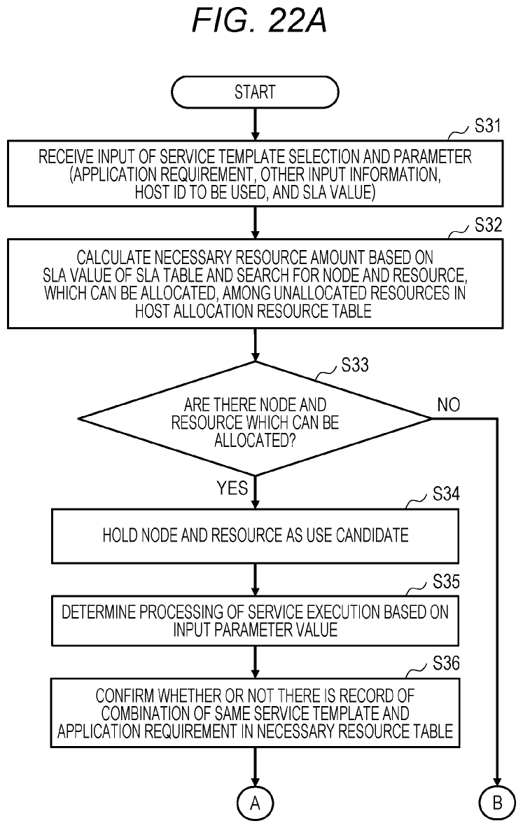

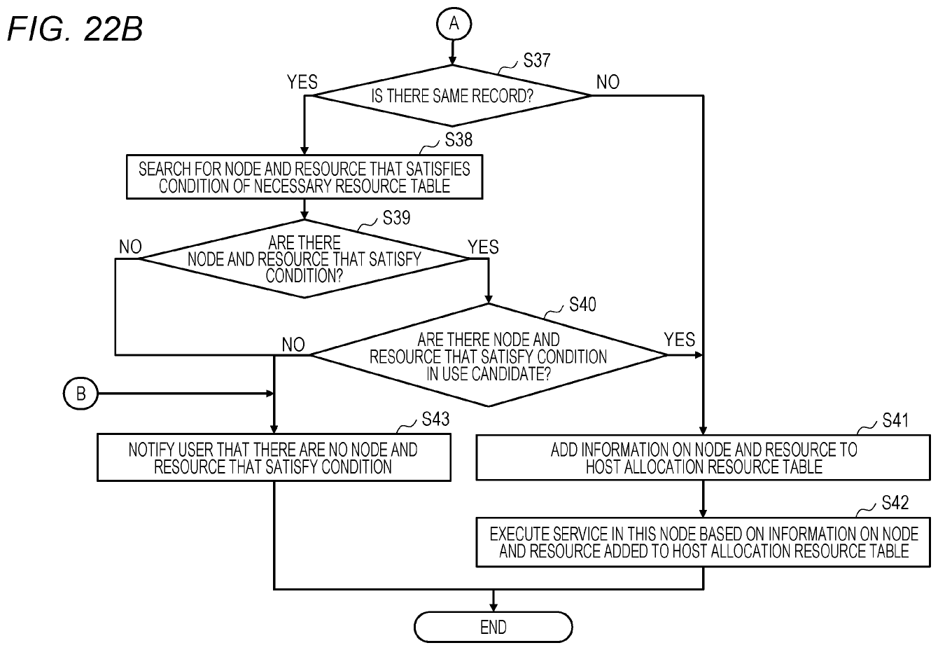

Hereinafter, the service execution processing of Embodiment 4 will be described. FIGS. 22A and 22B are flowcharts illustrating the service execution processing according to Embodiment 4.

First, in Step S31, the storage service management program 1212 receives a service template selection (template ID), a parameter (application requirement and other item information), a host ID to be used, and an SLA value, which are input by the user via the management terminal 3. The storage service management program 1212 updates the SLA table 1226 based on the received template ID, host ID to be used, and SLA value. The SLA table 1226 may be set for each user in advance.

Next, in Step S32, the storage service management program 1212 calculates the resource amount necessary for guaranteeing the SLA value in the SLA table 1226, and searches whether or not there is a node and a resource to which the calculated necessary resource amount can be allocated among unallocated resources in the host allocation resource table 1227. In Step S32, a method for calculating the necessary node and resource amount based on the SLA value in the SLA table 1226 uses a general necessary performance estimation method used in the calculation of an influence of the service in Step S24 of FIG. 13 of Embodiment 1. For example, when a guarantee of IOPS:100 in the SLA is desired, the CPU processing time is calculated from the reciprocal of IOPS, and whether there is a free CPU is searched. Similarly, the processing time for a memory, a port, and a drive is calculated, and the necessary resource is estimated.

Next, in Step S33, the storage service management program 1212 determines whether or not there are a node and resource, which can be allocated, as a result of the search in Step S32. In the storage service management program 1212, the processing proceeds to Step S34 when there are a node and resource, which can be allocated (YES in Step S33), and the processing proceeds to Step S43 in FIG. 22B when there is no resource which can be allocated (NO in Step S33).

Next, in step S34, the storage service management program 1212 temporarily stores the resource and node, which can be allocated, and are determined to exist in Step S33 as a use candidate in a storage area.

Steps S35 and S36 following Step S34, and Step S37 in FIG. 22B are similar to Steps S12, S13, and S14 in FIG. 12, respectively.

In Step S38 of FIG. 22B, the storage service management program 1212 searches for a node and resource that satisfy a condition for the necessary resource amount described in the record of the necessary resource table 1225, the record determined to be the same in step S27. Next, in Step S39, the storage service management program 1212 determines whether or not there is a node and resource that satisfy a condition for the necessary resource amount. In the storage service management program 1212, when there is a node and resource satisfying the necessary resource condition (YES in Step S39), the processing proceeds to Step S40, and when there is not the node and resource satisfying the necessary resource condition, the processing proceeds to Step S43.

In Step S40, the storage service management program 1212 determines whether or not the node and resource, which are determined to exist in Step S39, and satisfy the condition, exist in the use candidate temporarily stored in Step S34. In the storage service management program 1212, the processing proceeds to step S41 when the node and resource that satisfy the condition exist in the use candidate (YES in Step S40). On the other hand, in the storage service management program 1212, the processing proceeds to Step S43 when the node and resource that satisfy the condition do not exist in the use candidate (NO in Step S40).

In step S41, the storage service management program 1212 adds information on the node and resource determined to be capable of being allocated to the host used by the user in Step S33 to the host allocation resource table 1227. Next, in Step S42, based on information on the node and resource added to the host allocation resource table 1227 in Step S41, the storage service management program 1212 executes the service so as to allocate the corresponding resource in the corresponding node. By fixing and allocating the resource to each host, the accuracy of guaranteeing the SLA can be improved.

On the other hand, in Step S43, the storage service management program 1212 notifies the user that there are no node and resource that satisfy the condition. When Step S42 or Step S43 ends, the storage service management program 1212 ends the service execution processing of Embodiment 4.

Since the necessary resource table update processing is the same as in the embodiment, the description thereof will be omitted.

In the embodiment, it is validated whether the conditions of both the necessary resource amount based on the application requirement and the necessary resource amount for guaranteeing the SLA are satisfied, and a resource satisfying both the conditions is allocated to the host. When there is no condition for the necessary resource amount based on the application requirement, a resource that satisfies the condition for the necessary resource amount for guaranteeing the SLA is allocated.

Therefore, according to the embodiment, since it is possible to set a quality of a service (QoS), a cache memory logical division function, and the like based on the SLA value, the performance is guaranteed to the customer, as in Embodiment 1, it is possible to create and change a configuration more suitable for each customer environment in consideration of a load balance in an operation of the computer system.

The present invention is not limited to the above-described embodiment, and various modification examples are included. For example, the above embodiments have been described in detail in order to describe the present invention in an easy-to-understand manner, and are not necessarily limited to those including all the described configurations. As long as there is no contradiction, it is possible to replace a part of the configurations of one embodiment with the configuration of another embodiment, and it is also possible to add the configuration of another embodiment to the configuration of a certain embodiment. It is possible to perform addition, deletion, replacement, combination or separation of a configuration with respect to a part of the configurations of each embodiment. Further, the configurations and processing described in the embodiments can be appropriately separated, combined, or replaced based on a processing efficiency or a mounting efficiency.

What is claimed is:

1. A computer system that includes a plurality of nodes having a processor, and a storage device, the nodes processing data input and output to the storage device by a host by using the processor, the computer system comprising a management unit that holds a service template in which a service provided by the host is described, and a necessary resource table in which a resource amount of a resource necessary for the node is described so as to execute the service with a predetermined parameter,
wherein the management unit
receives input of the service template and the parameter,
calculates a necessary resource amount based on a combination of the input service template and parameter with reference to the necessary resource table,
selects a node that satisfies a condition for the calculated necessary resource amount, and executes a service for the service template, and
updates the necessary resource table based on a change in a load of the resource before and during the service is executed.

2. The computer system according to claim 1, wherein the management unit records the change in a load of the resource before and during the service is executed, and learns the recorded change in a load of the resource to update the necessary resource table.

3. The computer system according to claim 1, wherein the management unit calculates the necessary resource amount by using a ratio between the input parameter and a parameter in the resource table.

4. The computer system according to claim 1, wherein the management unit calculates a similarity between the input service template and input parameter, and a service template and parameter in the necessary resource table in which records are grouped, and calculates a necessary resource amount of the input service template and input parameter by using a necessary resource amount for a combination of the service template and the parameter of which the similarity is a predetermined value or more.

5. The computer system according to claim 1, wherein the management unit further calculates the necessary resource amount based on a service level agreement (SLA) for the service.

6. The computer system according to claim 1, which has a hyper-converged infrastructure configuration in which host processing for the service is performed on the node.

7. The computer system according to claim 1, further comprising a plurality of storage clusters including a plurality of the nodes and a management server including the management unit,
wherein the management unit
holds the necessary resource table for each of the storage clusters,
calculates a necessary resource amount based on a combination of the input service template and the input parameter which are received from each of the storage clusters with reference to the necessary resource table of the each storage cluster,
selects a node that satisfies a condition for the calculated necessary resource amount for each of the storage clusters, and
executes a service described in the selected service template received from each of the storage clusters in the selected node for each of the storage clusters.

8. An operation management method for a computer system that includes a plurality of nodes having a processor, and a storage device, the nodes processing data input and output to the storage device by a host by using the processor, the computer system including a management unit that holds a service template in which a service provided by the host is described, and a necessary resource table in which a resource amount of a resource necessary for the node is described so as to execute the service with a predetermined parameter, the method comprising causing the management unit to:
receive input of the service template and the parameter;
calculate a necessary resource amount based on a combination of the input service template and parameter with reference to the necessary resource table;
select a node that satisfies a condition for the calculated necessary resource amount, and execute a service for the service template; and
update the necessary resource table based on a change in a load of the resource before and during the service is executed.
